(19) United States
(12) Patent Application Publication
(10) Pub. No.: US 2025/0238801 A1
(43) Pub. Date: Jul. 24, 2025

(54) MERCHANT AND CUSTOMER AUTHENTICATION INTERFACE

(71) Applicant: Wells Fargo Bank, N.A., San Francisco, CA (US)

(72) Inventors: Matthew N. Wheeler, Charlotte, NC (US); Roxane Strong Whalen, Battle Ground, WA (US)

(21) Appl. No.: 18/419,755

(22) Filed: Jan. 23, 2024

(51) Int. Cl. G06Q 20/40; G06Q 20/20; G06Q 20/32; G06Q 20/36

(52) U.S. Cl. CPC G06Q 20/40145; G06Q 20/20; G06Q 20/321; G06Q 20/3221; G06Q 20/3267; G06Q 20/3276; G06Q 20/3278; G06Q 20/367; G06Q 20/4012; G06Q 2220/00

(57) ABSTRACT

A merchant device provides merchant data to a customer device. The merchant data cause a mobile application to launch on the customer device. Customer authentication data are received at a merchant server from the mobile application on the customer device. A customer is authenticated at the merchant server as a function of the customer authentication data. A line of communication is maintained between the customer device, the merchant server and the merchant device.

### TECHNICAL FIELD

Embodiments described herein generally relate to an interface for customer authentication by a merchant such as a bank or retail establishment, and in an embodiment, but not by way of limitation, the authentication of a bank customer by a bank teller using near field communication (NFC) between a customer mobile device and a bank teller personal identification number (PIN) terminal and an application programming interface (API) between the customer mobile device, the bank teller PIN terminal and a bank server.

### BACKGROUND

When a customer patronizes a business or merchant, the customer at times has to provide documents or means to identify the customer. For example, if the customer would like to pay by a personal check, the customer normally has to produce some form of identification like a driver's license. Even if the customer pays by credit card, sometimes the merchant requires an additional form of identification so that the merchant can verify that the credit card actually belongs to the customer.

In the specific situation of a customer going into a bank and executing transactions with a bank teller, the customer once again must produce some form of identification. In some situations, this identification process includes the customer inserting their bank card or debit card into a personal identification number (PIN) terminal, and then entering the customer's PIN to verify the identity of the customer. There are problems with this method such as if the customer forgets the PIN or forgets to bring their bank card to the bank, or even worse yet, the customer loses the bank or debit card.

In the customer and bank teller situation, after a customer is validated, the account information of the customer is normally displayed on a screen of the teller's computer terminal. However, because of the positioning of the teller's screen, the teller's screen is not normally visible to the customer. Consequently, if the teller wants to share some of the information on the teller's screen with the customer, the teller has to turn the screen towards the customer (risking a disconnect of the display terminal cables), or the customer has to lean over the teller's counter to view the screen (which is not possible if a barrier is present between the customer and teller for security or pandemic health concern reasons).

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 is a diagram of a system to authenticate a customer using a customer device and a merchant device according to some examples of the present disclosure.

FIG. 2 is a more detailed diagram of a system to authenticate a customer using a customer device and a merchant device according to some examples of the present disclosure.

FIGS. 3A and 3B are a block diagram of operations and features of a system to authenticate a customer using a customer device and a merchant device according to some examples of the present disclosure.

FIGS. 4A, 4B, 4C, 4D and 4E are example displays on a customer device according to some examples of the present disclosure.

FIG. 5 is a block diagram of a computer architecture upon which one or more embodiments of the present disclosure can execute according to some examples of the present disclosure.

### DETAILED DESCRIPTION

The inventors have recognized a need for a more secure and personalized authentication process at a merchant point of sale and/or in interactions with a bank teller at a bank. An embodiment provides a more secure and user-friendly manner to authenticate a customer at a merchant location such as a bank or retail establishment. As an example, this disclosure discusses the situation of a bank customer and a bank teller. However, it is to be understood that the invention is not limited to that embodiment or other embodiments disclosed herein. For example, one or more disclosed embodiments could be used at a point-of-sale terminal at a retail store or restaurant, a visit to a customer's insurance agent, or a visit to a customer's certified financial planner.

In an embodiment, a bank customer uses their mobile device to tap at a teller personal identification number (PIN) terminal. Via near field communication (NFC), the customer device receives a token push from the teller PIN terminal. The token causes the launch of a mobile app on the customer's mobile device. In an embodiment, the token push is not received by a customer's mobile wallet on the customer device, but rather is received by the mobile app. Because of this design, the embodiment functions regardless of whether the customer has a bank or debit card loaded into a payment app such as Apple Pay on their device. The customer then authenticates themselves through the mobile app. The authentication information entered by the customer via the mobile app is transmitted to a bank server via an application program interface (API), and a personalized welcome message is presented on the customer device.

After the customer executes the NFC authentication, the teller pin terminal and the customer device are paired, and this maintains the session between the mobile app on the customer device, and the teller pin terminal (and in many cases, a bank server). The customer device then becomes a part of an interactive joint session between the customer and the teller. The customer can see on their mobile device all the information that is displayed on the screen of the teller's computer; for example, all the work that the teller is performing on the customer's behalf. For transactions requiring additional customer input (e.g., a consent such as “Is this amount correct?”), the customer can consent/confirm details on their mobile device.

At the conclusion of the session between the customer and the teller, the customer can receive a digital receipt of everything that was done for the customer by the teller. For example, the date, time, branch location and customer identifying information can be reported to the customer, along with actions that were performed on behalf of the customer such as informing the customer that the address of the customer was updated, a check with its identifying check number was deposited in a particular account for the customer, and/or a new debit card has been ordered for the customer and the address to which that the debit card will be shipped.

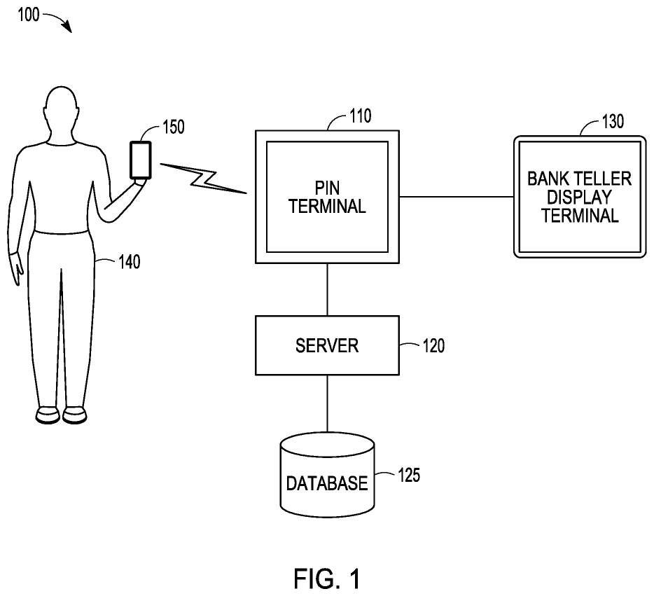

FIG. 1 is a diagram of a system 100 to authenticate a customer 140 using a customer device and a merchant device according to some examples of the present disclosure. The system 100 can be used for authenticating a customer at a bank using a customer mobile device and a teller PIN terminal. The system 100 includes a teller PIN terminal 110. The teller PIN terminal 110 is coupled to a server 120, which is coupled to and/or in communication with one or more databases 125. The databases 125 contain customer identification information and customer account information. The teller PIN terminal 110 is further connected to a teller display terminal 130. Upon entering a bank location, the customer 140 taps their phone 150 or other mobile device to the teller PIN terminal 110, and via near field communications (NFC), a personalized process of customer identification and authentication is commenced.

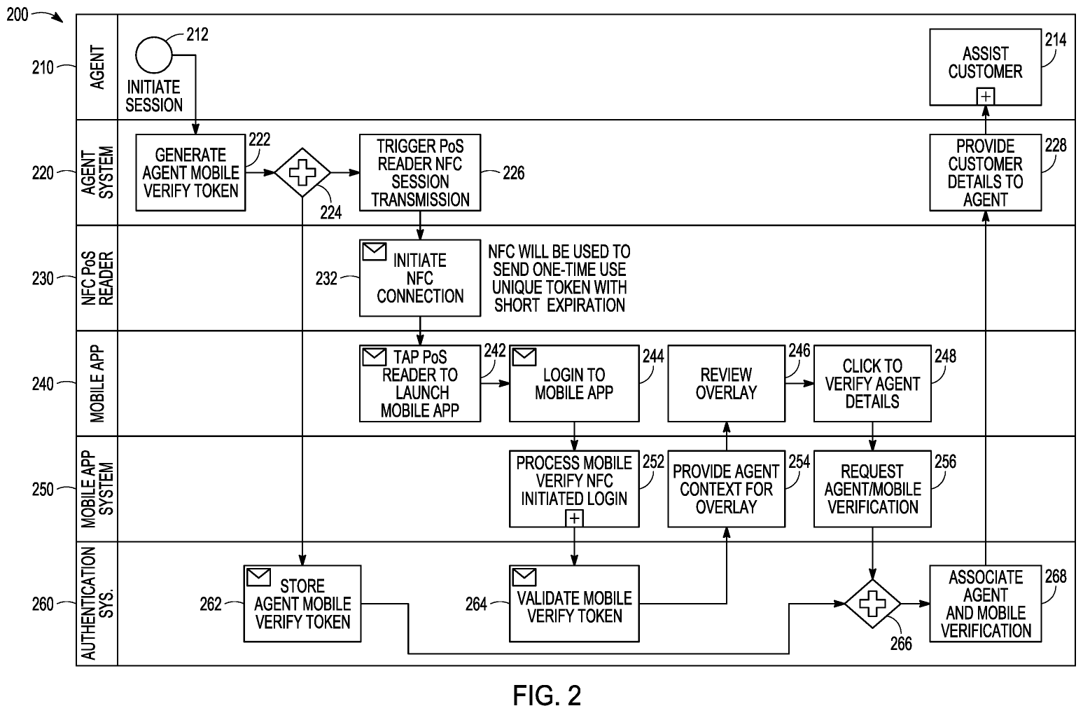

FIG. 2 is a more detailed diagram of a system 200 to authenticate a customer using a customer device and a merchant device according to some examples of the present disclosure. The system 200 can be used in particular as an authentication system involving a bank customer mobile device, a bank teller PIN terminal, and a bank server. Referring now specifically to FIG. 2, an agent 210 initiates the customer authentication session at 212. In an embodiment, the agent 210 is a bank teller PIN terminal. The agent 210, via an agent system 220, generates an agent mobile verify token at 222. This agent mobile verify token 222 is stored at 262 in an authentication system 260. The agent mobile verify token is transmitted to the authentication system 260 via an application program interface (API). The authentication system 260 in an embodiment is a bank server. The agent mobile token 222 further triggers at 226 a transmission of a NFC signal, which initiates an NFC connection signal 232 in an NFC reader 230. As noted in FIG. 2, NFC is used to send a one-time unique token which has a short expiration duration.

The unique token is received by a mobile app 240 via tapping the NFC reader 230 with a customer device (e.g., a mobile phone) at 242, which launches a mobile app on the customer device. The customer logs into the mobile app at 244. In a mobile app system 250, the NFC-initiated login is processed at 252, and the mobile verify token is validated in the authentication system 260 at 264. After validation at 264, the mobile app system 250 provides an overlay or welcome screen on the agent (e.g., PIN terminal) at 254, and the overlay or welcome screen is displayed at 246 in the mobile app 240. The mobile app 240 receives a click from the customer at 248 to verify details of the agent, and agent/mobile verification is requested in the mobile app system 250 at 256. This verification is combined with the stored agent mobile verify token at 266, and at 268, the agent mobile verify token and agent/mobile verification are associated. After association, customer details are provided to the agent (e.g., PIN terminal) at 228 in the agent system 220, and the agent or bank teller can then assist the customer at 214.

An example of a general flow of the system in a banking situation is as follows. A customer arrives in a bank branch and enters a teller line. The customer arrives at the teller window and taps their phone to the teller or branch PIN terminal (e.g., an NFC tap). In another embodiment, the customer can use their mobile device to scan a quick response (QR) code on the display of the teller PIN terminal. The tap (or QR scan) launches a mobile app on the customer's device. After this tap (or scan) and launch, the mobile app initiates an authentication process on the customer device and after authentication, the customer device is paired with the teller device and a bank server in a communication session. It is noted that the customer can biometrically authenticate themselves via the mobile app (e.g., by using a faceID, a fingerprint, etc.). The authentication data are then transmitted to the bank's servers and databases. Once authenticated, the customer receives a personalized welcome message such as “Welcome! You've successfully authenticated at the Branch at 123 Main Street.” The welcome message can also include information such as the teller's name.

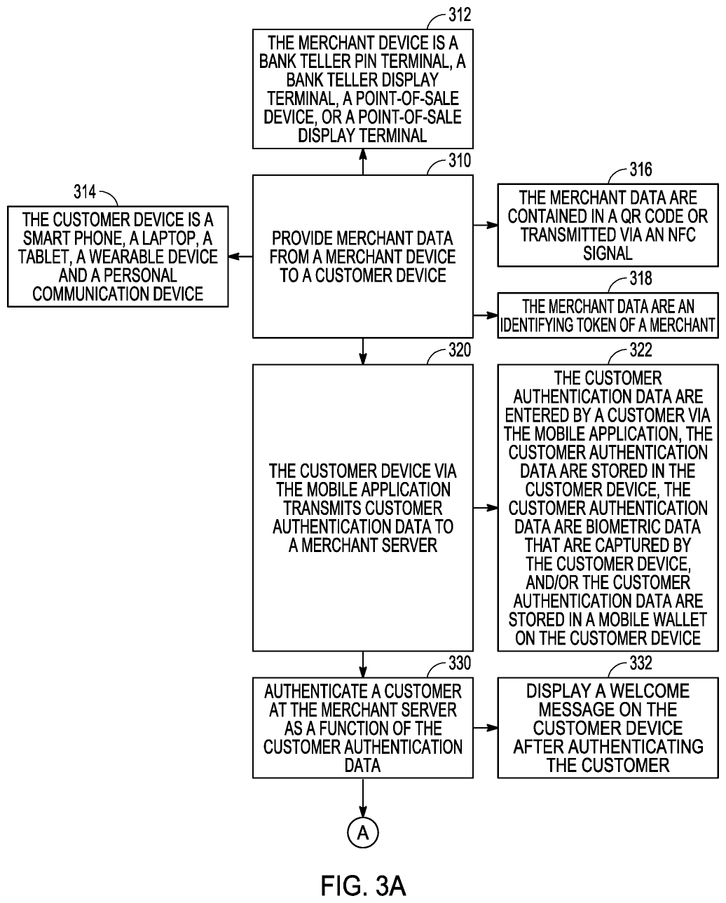

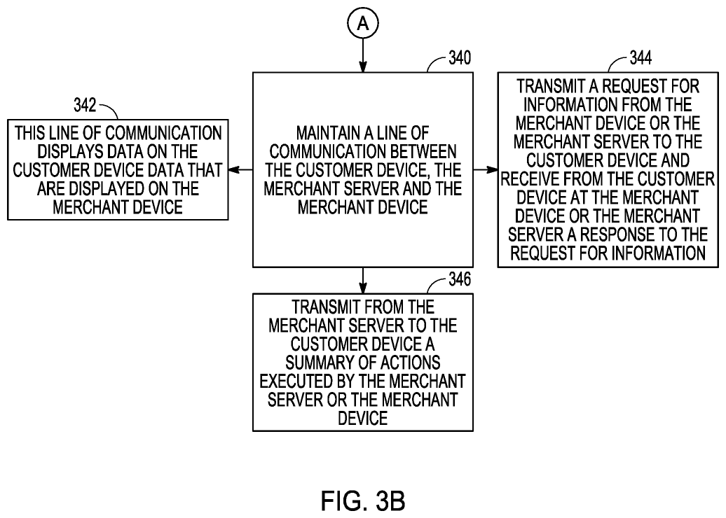

FIGS. 3A and 3B illustrate an example embodiment of operations and features of a system to authenticate a customer using a customer device and a merchant device according to some examples of the present disclosure. FIGS. 3A and 3B include a number of process and feature blocks 310-346. Though arranged substantially serially in the example of FIGS. 3A and 3B, other examples may reorder the blocks, omit one or more blocks, and/or execute two or more blocks in parallel using multiple processors or a single processor organized as two or more virtual machines or sub-processors.

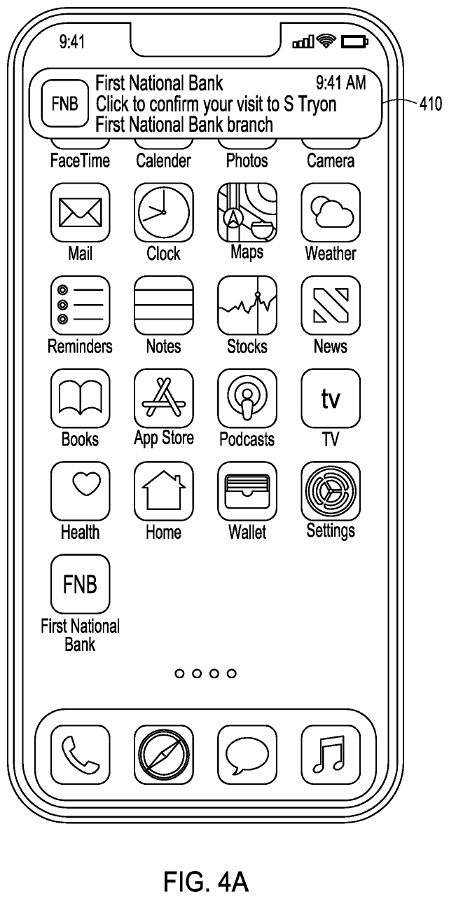

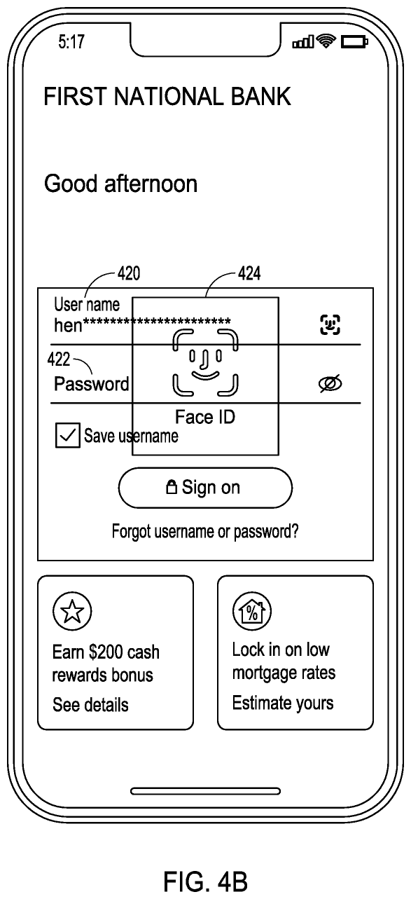

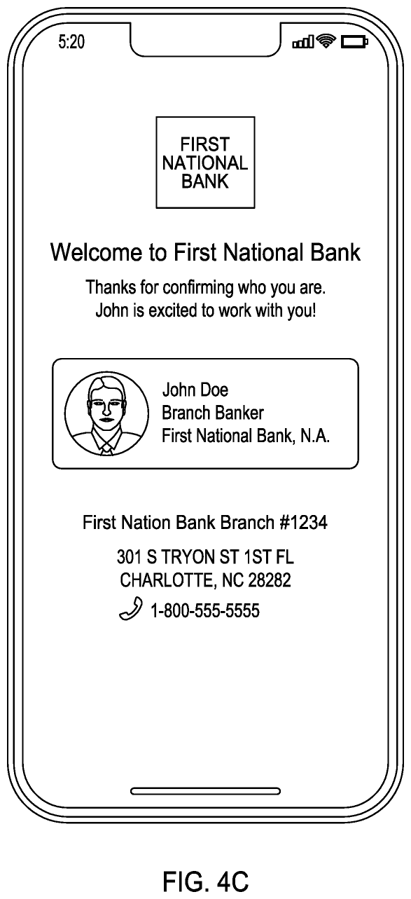

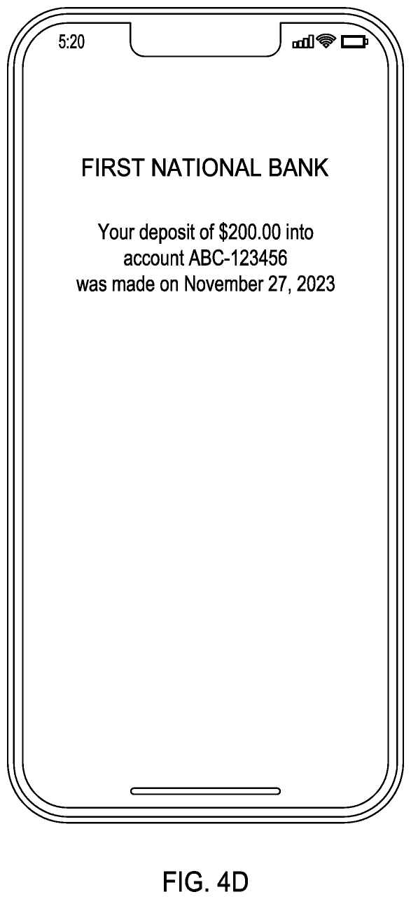

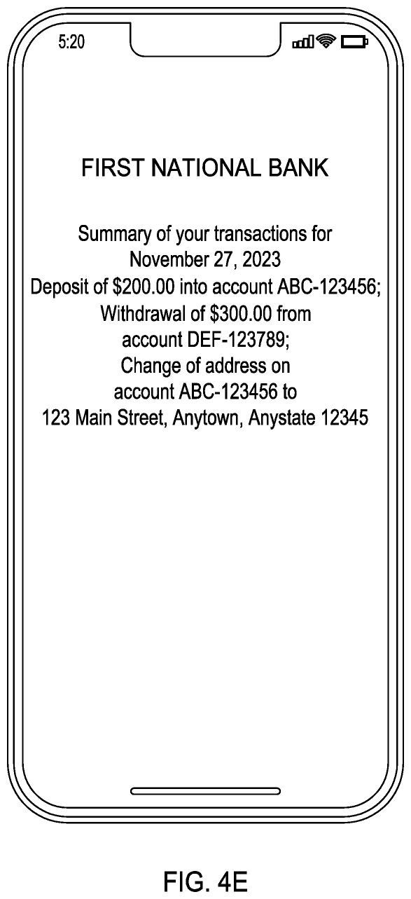

Referring now specifically to FIGS. 3A and 3B, at 310, merchant data are provided from a merchant device to a customer device. The merchant device can be a bank teller personal identification number (PIN) terminal, a bank teller display terminal, a point-of-sale device, or a point-of-sale display terminal (312). The customer device can, for example, be one or more of a smart phone, a laptop, a tablet, a wearable device and a personal communication device (314). As indicated at 316, the merchant data can be contained in a quick response (QR) code (e.g., in the code itself or from a URL contained in the code) or transmitted via a near field communication (NFC) signal. The merchant data are an identifying token of a merchant (318), and after the customer device recognizes the identifying token, the merchant token causes a mobile application to launch on the customer device. In an embodiment, as illustrated in FIG. 4A, a request 410 for a confirmation from the customer can be displayed on the customer device.

At 320, the customer device via the mobile application transmits customer authentication data to a merchant server (e.g., a bank server or a retail merchant server). As indicated at 322, the customer authentication data can be entered by a customer via the mobile application and transmitted to the merchant server, the customer authentication data can be stored in the customer device and transmitted to the merchant server, the customer authentication data can be biometric data that are captured by the customer device and transmitted to the merchant server, or the customer authentication data can be stored in a mobile wallet on the customer device and transmitted to the merchant server. FIG. 4B illustrates a customer device wherein the user enters the customer authentication data via a username 420 and a password 422, or via biometric recognition 424. These customer authentication data can include one or more of a name, an account number, or a personal identification number (PIN).

At 330, a customer is authenticated at the merchant server as a function of the customer authentication data. At 332, a welcome message is displayed on a display of the customer device after authenticating the customer. FIG. 4C illustrates an example of a welcome message.

At 340, a line of communication is maintained between the customer device, the merchant server and the merchant device. This line of communication can display data on the customer device that are displayed on the merchant device (342). This line of communication can further be used for transmitting a request for information from the merchant device or the merchant server to the customer device, and for receiving from the customer device at the merchant device or the merchant server a response to the request for information (344). FIG. 4D illustrates an example of a display on the customer device seeking confirmation of a deposit amount in a certain bank account. The line of communication further can be used for transmitting from the merchant server to the customer device a summary of actions executed by one or more of the merchant server or the merchant device (346). FIG. 4E illustrates an example of a display on the customer device of the summary of actions performed on behalf of the customer during the customer's visit.

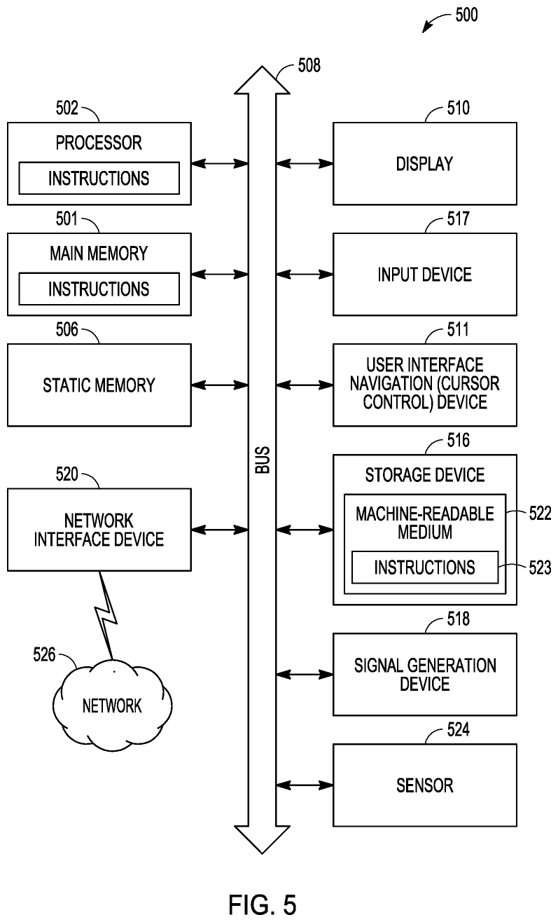

FIG. 5 is a block diagram illustrating a computing and communications platform 500 in the example form of a general-purpose machine on which some or all the operations of FIGS. 3A and 3B may be carried out according to various embodiments. In certain embodiments, programming of the computing platform 500 according to one or more particular algorithms produces a special-purpose machine upon execution of that programming. In a networked deployment, the computing platform 500 may operate in the capacity of either a server or a client machine in server-client network environments, or it may act as a peer machine in peer-to-peer (or distributed) network environments.

Example computing platform 500 includes at least one processor 502 (e.g., a central processing unit (CPU), a graphics processing unit (GPU) or both, processor cores, compute nodes, etc.), a main memory 501 and a static memory 506, which communicate with each other via a link 508 (e.g., bus). The computing platform 500 may further include a video display unit 510, input devices 517 (e.g., a keyboard, camera, microphone), and a user interface (UI) navigation device 511 (e.g., mouse, touchscreen). The computing platform 500 may additionally include a storage device 516 (e.g., a drive unit), a signal generation device 518 (e.g., a speaker), a sensor 524, and a network interface device 520 coupled to a network 526.

The storage device 516 includes a non-transitory machine-readable medium 522 on which is stored one or more sets of data structures and instructions 523 (e.g., software) embodying or utilized by any one or more of the methodologies or functions described herein. The instructions 523 may also reside, completely or at least partially, within the main memory 501, static memory 506, and/or within the processor 502 during execution thereof by the computing platform 500, with the main memory 501, static memory 506, and the processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions 523. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

### EXAMPLES

Example No. 1 is a process comprising providing merchant data from a merchant device to a customer device, the merchant data causing a mobile application to launch on the customer device; receiving customer authentication data at a merchant server from the mobile application on the customer device; authenticating a customer at the merchant server as a function of the customer authentication data; and maintaining a line of communication between the customer device, the merchant server and the merchant device.

Example No. 2 includes all the features of Example No. 1, and optionally includes a process wherein the merchant data comprise a quick response (QR) code or a near field communication (NFC) signal.

Example No. 3 includes all the features of Example Nos. 1-2, and optionally includes a process wherein the merchant data comprise an identifying token of a merchant.

Example No. 4 includes all the features of Example Nos. 1-3, and optionally includes a process wherein the customer authentication data are entered by a customer via the mobile application and transmitted to the merchant server, the customer authentication data are stored in the customer device and transmitted to the merchant server, the customer authentication data comprise biometric data captured by the customer device and transmitted to the merchant server, or the customer authentication data are stored in a mobile wallet on the customer device and transmitted to the merchant server.

Example No. 5 includes all the features of Example Nos. 1-4, and optionally includes a process wherein the customer authentication data comprise one or more of a name, an account number or a personal identification number (PIN).

Example No. 6 includes all the features of Example Nos. 1-5, and optionally includes a process wherein the merchant device comprises one or more of a bank teller personal identification number (PIN) terminal, a bank teller display terminal, a point-of-sale device, or a point-of-sale display terminal.

Example No. 7 includes all the features of Example Nos. 1-6, and optionally includes a process wherein the customer device comprises one or more of a smart phone, a laptop, a tablet, a wearable device and a personal communication device.

Example No. 8 includes all the features of Example Nos. 1-7, and optionally includes a process comprising displaying a welcome message on a display of the customer device after authenticating the customer.

Example No. 9 includes all the features of Example Nos. 1-8, and optionally includes a process wherein the line of communication comprises displaying on the customer device data that are displayed on the merchant device.

Example No. 10 includes all the features of Example Nos. 1-9, and optionally includes a process comprising transmitting from the merchant server to the customer device a summary of actions executed by one or more of the merchant server or the merchant device.

Example No. 11 includes all the features of Example Nos. 1-10, and optionally includes a process comprising transmitting, via the line of communication, a request for information from the merchant device or the merchant server to the customer device; and receiving from the customer device at the merchant device or the merchant server a response to the request for information.

Example No. 12 is a machine-readable medium comprising instructions that when executed by a processor executes a process comprising providing merchant data from a merchant device to a customer device, the merchant data causing a mobile application to launch on the customer device; receiving customer authentication data at a merchant server from the mobile application on the customer device; authenticating a customer at the merchant server as a function of the customer authentication data; and maintaining a line of communication between the customer device, the merchant server and the merchant device.

Example No. 13 includes all the features of Example No. 12, and optionally includes a machine-readable medium wherein the merchant data comprise a quick response (QR) code or a near field communication (NFC) signal; and wherein the merchant data comprise an identifying token of a merchant.

Example No. 14 includes all the features of Example Nos. 12-13, and optionally includes a machine-readable medium wherein the customer authentication data are entered by a customer via the mobile application and transmitted to the merchant server, the customer authentication data are stored in the customer device and transmitted to the merchant server, the customer authentication data comprise biometric data captured by the customer device and transmitted to the merchant server, or the customer authentication data are stored in a mobile wallet on the customer device and transmitted to the merchant server.

Example No. 15 includes all the features of Example Nos. 12-14, and optionally includes a machine-readable medium wherein the customer authentication data comprise one or more of a name, an account number or a personal identification number (PIN).

Example No. 16 includes all the features of Example Nos. 12-15, and optionally includes a machine-readable medium wherein the merchant device comprises a bank teller device or a point-of-sale device; and wherein the customer device comprises one or more of a smart phone, a laptop, a tablet, a wearable device and a personal communication device.

Example No. 17 includes all the features of Example Nos. 12-16, and optionally includes a machine-readable medium wherein the customer device comprises one or more of a smart phone, a laptop, a tablet, a wearable device and a personal communication device.

Example No. 18 includes all the features of Example Nos. 12-17, and optionally includes a machine-readable medium wherein the line of communication comprises displaying on the customer device data that are displayed on the merchant device.

Example No. 19 includes all the features of Example Nos. 12-18, and optionally includes a machine-readable medium comprising instructions for transmitting, via the line of communication, a request for information from the merchant device to the customer device; and receiving at the merchant device from the customer device a response to the request for information.

Example No. 20 is a system comprising a merchant server; a merchant device; a customer device; and a communication protocol coupling the merchant server, the merchant device and the customer device; wherein the system is operable for providing merchant data from a merchant device to a customer device, the merchant data causing a mobile application to launch on the customer device; receiving customer authentication data at a merchant server from the mobile application on the customer device; authenticating a customer at the merchant server as a function of the customer authentication data; and maintaining a line of communication between the customer device, the merchant server and the merchant device.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A process, comprising:
receiving by a customer device merchant data from a merchant device;
launching a mobile app on the customer device in response to receiving the merchant data;
receiving customer authentication data by the mobile app on the customer device;
transmitting the customer authentication data to a merchant server for authentication of the customer device; and
pairing the customer device and the merchant device after the authentication to establish a joint interactive session between the customer device and the merchant device.

2. The process of claim 1, wherein the merchant device includes a teller personal identification number (PIN) pad and a teller terminal, wherein receiving the merchant data includes receiving the merchant data from the teller PIN pad and wherein pairing the customer device includes pairing the customer device with the teller terminal.

3. The process of claim 1, wherein the merchant data comprise a quick response (QR) code or a near field communication (NFC) signal.

4. The process of claim 3, wherein the merchant data comprise an identifying token of a merchant.

5. The process of claim 1, wherein the customer authentication data are entered by a customer via the mobile application and transmitted to the merchant server, the customer authentication data are stored in the customer device and transmitted to the merchant server, the customer authentication data comprise biometric data captured by the customer device and transmitted to the merchant server, or the customer authentication data are stored in a mobile wallet on the customer device and transmitted to the merchant server.

6. The process of claim 1, wherein the customer authentication data comprise one or more of a name, an account number or a personal identification number (PIN).

7. The process of claim 1, wherein the merchant device comprises one or more of a bank teller personal identification number (PIN) terminal, a bank teller display terminal, a point-of-sale device, or a point-of-sale display terminal.

8. The process of claim 1, wherein the customer device comprises one or more of a smart phone, a laptop, a tablet, a wearable device or a personal communication device.

9. The process of claim 1, comprising displaying a welcome message on a display of the customer device after authenticating the customer.

10. The process of claim 1, wherein the joint interactive session comprises displaying on the customer device data that are displayed on the merchant device.

11. The process of claim 1, comprising receiving at the customer device a summary of actions executed by one or more of the merchant server or the merchant device.

12. The process of claim 1, comprising receiving at the customer device a request for information from the merchant device or the merchant server; and transmitting from the customer device to the merchant device or the merchant server a response to the request for information.

13. A process comprising:
transmitting merchant data to a customer device from a merchant device, the merchant data causing a mobile app to launch on the customer device;
receiving customer authentication data at the merchant device from the customer device;
transmitting the customer authentication data to a merchant server for authentication of the customer device; and
pairing the customer device and the merchant device after the authentication to establish a joint interactive session between the customer device and the merchant device.

14. The process of claim 13, wherein the merchant device includes a teller PIN pad and a teller terminal; wherein transmitting the merchant data includes transmitting the merchant data from the teller PIN pad to the customer device; and wherein pairing the customer device includes pairing the customer device with the teller terminal.

15. The process of claim 14, wherein the joint interactive session comprises transmitting by the merchant device data that are displayed on the teller terminal for display on the customer device.

16. The process of claim 13, comprising transmitting from the merchant device to the customer device a summary of actions executed by the merchant device for display on the customer device.

17. A customer device comprising:
a processor; and
a memory;
wherein the processor and memory are operable for:
receiving by the customer device merchant data from a merchant device;
launching a mobile app on the customer device in response to receiving the merchant data;
receiving customer authentication data by the mobile app on the customer device;
transmitting the customer authentication data to a merchant server for authentication of the customer device; and
pairing the customer device and the merchant device after the authentication to establish a joint interactive session between the customer device and the merchant device.

18. The customer device of claim 17, wherein the merchant device includes a teller personal identification number (PIN) pad and a teller terminal, wherein receiving the merchant data includes receiving the merchant data from the teller PIN pad and wherein pairing the customer device includes pairing the customer device with the teller terminal.

19. The process of claim 1, wherein the customer authentication data are entered by a customer via the mobile application and transmitted to the merchant server, the customer authentication data are stored in the customer device and transmitted to the merchant server, the customer authentication data comprise biometric data captured by the customer device and transmitted to the merchant server, or the customer authentication data are stored in a mobile wallet on the customer device and transmitted to the merchant server.

20. The customer device of claim 17, wherein the customer device comprises one or more of a smart phone, a laptop, a tablet, a wearable device or a personal communication device.
